(19) United States
(12) Patent Application Publication
(10) Pub. No.: US 2011/0037850 A1
(43) Pub. Date: Feb. 17, 2011

(54) SURVEILLANCE SYSTEM FOR MONITORING SECURITY PERSONNEL

(75) Inventor: Chia-Chun TSOU, Taipei County (TW)

Correspondence Address: Muncy, Geissler, Olds & Lowe, PLLC, 4000 Legato Road, Suite 310, FAIRFAX, VA, 22033, US

(73) Assignee: UTECHZONE Co., LTD., Taipei County (TW)

(21) Appl. No.: 12/854,485

(22) Filed: Aug. 11, 2010

(30) Foreign Application Priority Data
Aug. 12, 2009 (TW) 098127047

(51) Int. Cl. H04N 7/18

(52) U.S. Cl. 348/143; 348/E07.085

(57) ABSTRACT

A surveillance system for monitoring mental concentration of a worker, capable of being installed in a control room, includes:

an image capture device for capturing eye images of the worker;

an inspection unit coupled to the image capture device for inspecting motion status of an eye of the worker and calculating positions of a screen where the eye stares; and

an analysis unit coupled to the inspection unit and configured to analyze the calculated position information transferred from the inspection unit in order to identify the mental concentration and quality of the worker.

### BACKGROUND OF INVENTION

1. Field of Invention

This invention relates to a smart surveillance system and more particularly to a surveillance and analysis system for assisting the alertness and efficiency of a security guard observing the monitors of a security system.

2. Related Prior Art

As the quality of human life rises, industries such as security service firms, security monitoring equipments, and security management services are getting popular. In a conventional security management system, alarm devices are deployed in every passageway and cameras are mounted on all corners of a protected area to capture images day and night. Due to the use of a greater number of cameras, a multi-image/single screen system is used for the security guard to view all the real-time images captured from those cameras at one time.

However, due to the long duty hours, the security guard on duty may fall sleep, read papers or magazines, and so forth. It was found that security guard often become lack of concentration while on duty. Eventually, it was recognized that human person could not reliably monitor the “real-time” images from one or several cameras for long “watch” periods of time because of tiredness, outside interferences, or the multi-split screen. However, an efficient security control highly relies on whether the guard could efficiently observe all sections of the split screen and take instant actions to an abnormal condition. If the guard could not efficiently observe all sections of the split screen, the guard fails to make good use of advanced and expensive security management system, causing loopholes of security surveillance and the related lost including life or property. The efforts to buy and build up the expensive security system are in vain.

### SUMMARY OF INVENTION

In view of the above, the present invention provides a surveillance system for monitoring the mental concentration of a security guard. To solve the aforementioned problem, the pupil tracking technology is employed to track vision changes of the eye of the security guard as well as a path where the eye stares. In this way, the present invention surpasses conventional security system and is able to quantify security controls and make sure that the surveillance quality of the security guard is under control and therefore gives a solution to the long-term unsolved technical problems.

It is therefore an object of the invention to provide a surveillance system which can monitor the mental concentration and the observing scope of the security guard observing each section of the multi-split screen in order to make sure that the security guard truly stares at the split screen. Further, the surveillance system can immediately take action to warn the guard once an abnormal condition is detected. The surveillance system also can record the history analysis of the monitoring condition for further analysis. By this way, the surveillance system can help the security guard to take suitable and enough attention to every monitoring spot, and reminds the guard to take instant action if any monitoring spot does not get enough attention from the guard and thereby make sure every spot is safe.

In one embodiment, there is provided a surveillance system for monitoring the mental concentration of a worker. The surveillance system may be installed in a control room of a security system and includes an image capture device for capturing eye images of the worker; an inspection unit coupled to the image capture device for inspecting motion status of an eye of the worker and calculating positions of a screen where the eye stares; and an analysis unit coupled to the inspection unit and configured to analyze the calculated position information transferred from the inspection unit in order to identify the mental concentration and quality of the worker.

### BRIEF DESCRIPTION OF DRAWINGS

FIG. 1 is a block diagram of a surveillance system in accordance with one embodiment of the present invention;

### DETAILED DESCRIPTION OF PREFERRED EMBODIMENTS

Further features and advantages of the present invention will be appreciated by review of the drawing and the following detailed description of the invention.

It is an object of the invention to provide a surveillance system which can help a worker to effectively observing a split screen.

According to one embodiment of this invention, the surveillance system for monitoring the mental concentration of a worker may be installed in a control room of a security system and includes an image capture device for capturing eye images of the worker; an inspection unit coupled to the image capture device for inspecting motion status of an eye of the worker and calculating positions of a screen where the eye stares; and an analysis unit coupled to the inspection unit and configured to analyze the calculated position information transferred from the inspection unit in order to identify the mental concentration and the quality of the worker observing the screen.

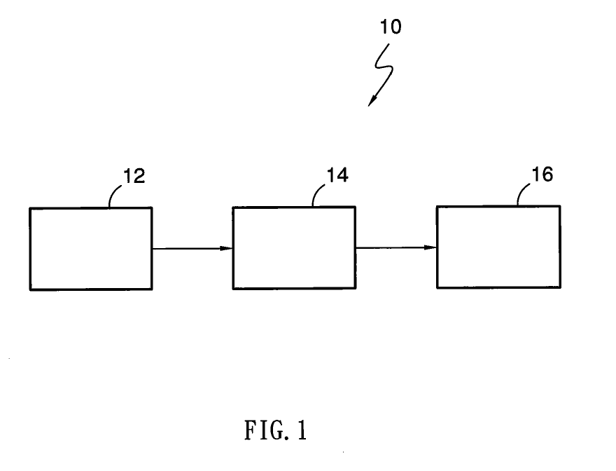

FIG. 1 is a block diagram of a surveillance system for monitoring the mental concentration of a security guard according to one embodiment of the present invention. In this embodiment, the surveillance system 10 may be mounted on a security monitoring equipment for monitoring whether the security guard is truly watching all sections of a multi-split screen. The surveillance system 10 mainly includes an image capture device 12, an inspection unit 14 and an analysis unit 16.

In this embodiment, the image capture device 12 is a CCD (charged coupled device) camera. The image capture device 12 is arranged to focus on at least one eye of a security guard observing a monitor. While the eye of the security guard moves around and is irradiated by light, the image capture device 12 continually captures eye images of the security guard, and transfers the continuous captured eye images to the inspection unit 14 that is coupled to the image capture device 12.

The inspection unit 14 is configured to inspect motion status of the eye and analyze the detected motion status of the eye with the help of a computer. By analyzing the continuous captured eye images, the inspection unit 14 identifies the pupil of the eye and calculates motion position and size of the pupil. Afterward, the inspection unit 14 evaluates a region which surrounds the pupil shown in the eye image so as to calculate which part of the screen the eye stares at and which direction the eye stares in.

When the eye moves in any direction and switches to any other position, the motion path, object and time spent on the screen of the eye of the security guard can be measured and identified in order to make sure that the security guard is truly observing each section of the multi-split screen. That is, every corner of the protected area is under the guard's control.

By analyzing the calculated position information of the inspection unit 14, the analysis unit 16, which is coupled to the inspection unit 14, is able to calculate the extent and density of observation on each section of the multi-split screen and identify the metal concentration and quality of the security guard observing the screen so as to make sure that every guarded area is safe. If any one of the guarded areas does not meet a predetermined security standard, the analysis unit 16 sends out a warning to the guard. For example, a red light may be turned on in an area to remind the security guard to pay more attention on that area.

According to the present invention, the pupil tracking technology and the image capture device are utilized to track vision changes of the eye of the security guard as well as the path where the eye stares. The surveillance system can monitor the mental concentration and the observing scope of the security guard observing each section of the multi-split screen to help the security guard to meet the security standard and therefore enhance the surveillance quality of the security guard. In this way, the present invention solves the long-term technical problems of the conventional security system of failing to quantify security controls, and makes sure that the security guard is truly observing the split screen. Besides, the surveillance system can take instant actions to warn the security guard once an abnormal condition of the guard is detected, and also can record the history analysis of the monitoring condition for further analysis. Accordingly, the surveillance system helps the security guard to take suitable and enough attention to every monitoring spot, and reminds the guard to take instant action if any monitoring spot does not get enough attention from the guard so as to make sure that every spot is safe.

It will be appreciated that although a particular embodiment of the invention has been shown and described, modifications may be made. It is intended in the claims to cover such modifications which come within the spirit and scope of the invention.

The invention claimed is:

1. A surveillance system for monitoring mental concentration of a worker, comprising:
an image capture device configured to capture eye images of the worker;
an inspection unit coupled to the image capture device for inspecting motion status of an eye of the worker and calculating positions of a screen where the eye stares; and
an analysis unit coupled to the inspection unit and configured to analyze the calculated position information transferred from the inspection unit in order to identify the mental concentration and quality of the worker.

2. The surveillance system of claim 1 wherein the image capture device is a CCD (Charged Coupled Device) camera.

3. The surveillance system of claim 1 wherein the inspection unit identifies the pupil of the eye from the continuous captured eye images.

4. The surveillance system of claim 1 wherein the inspection unit analyzes the images and calculates position and size of the pupil.

5. The surveillance system of claim 1 wherein the inspection unit evaluates a region surrounding the pupil shown in the eye image to detect position of the eye as well as gaze direction of the eye.

6. The surveillance system of claim 1 wherein the analysis unit calculates the extent and density of observation on each section of the multi-split screen.

7. The surveillance system of claim 1 wherein the analysis unit is capable of sending out a warning to fulfill the surveillance function.

8. The surveillance system of claim 1 wherein the analysis unit is capable of recording history analysis of the monitoring condition.
